(19) United States
(12) Patent Application Publication
(10) Pub. No.: US 2004/0187469 A1
(43) Pub. Date: Sep. 30, 2004

(54) Hay spreading apparatus

(76) Inventor: Richard G. Price, Sicily Island, LA (US)

Correspondence Address: John M. Harrison, 2139 E. Bert Kouns, Shreveport, LA, 71105, US

(21) Appl. No.: 10/795,912

(22) Filed: Mar. 8, 2004

Related U.S. Application Data
(60) Provisional application No. 60/453,187, filed on Mar. 11, 2003.

(51) Int. Cl. A01D 85/00

(52) U.S. Cl. 56/365

(57) ABSTRACT

A hay spreading apparatus is particularly adaptable for spreading round bales of hay and includes a freely-rotating roller drum mounted on a fixed or adjustable boom connected to the front or rear end of a tractor, to facilitate pushing a bale of hay and spreading the hay over a selected area of ground. In a first preferred embodiment a fixed boom includes a fixed boom frame rotatably mounting a drum spindle extending through the center of a roller drum. The fixed boom also typically includes a pair of fixed boom connectors extending from the fixed boom frame to the tractor frame to suspend the roller drum above the ground. In another preferred embodiment of the invention an adjustable boom typically includes a pair of parallel boom connectors pivotally attached to the tractor frame and to an adjustable boom frame rotatably carrying a roller drum by means of a drum spindle. A hydraulic cylinder and piston are pivotally secured to the tractor frame and the adjustable boom frame, respectively, for adjusting the adjustable boom frame and the roller drum with respect to the ground. In both the fixed and the adjustable boom embodiments the tractor is maneuvered to position the roller drum against a hay bale and the tractor is operated to contact the roller drum with the bale and facilitate rotation of the roller drum against the hay bale and unrolling of the respective layers of hay or breaking up the bale as the bale is pushed along the ground.

### CROSS-REFERENCE TO RELATED APPLICATIONS

This application claims the benefit of and incorporates by reference U.S. Provisional Application Serial No. 60/453,187, filed Mar. 11, 2003.

### SUMMARY OF THE INVENTION

This invention relates to the breaking up of hay bales and spreading hay over a selected area of ground to facilitate better access to the hay by cattle. More particularly, the invention includes a hay spreading apparatus for breaking up and spreading both square and round bales of hay, but particularly adapted for spreading round bales of hay, wherein a freely-rotating roller drum is journalled for rotation on a frame that is fixed or adjustably attached to the front or rear end of a vehicle such as a tractor, for contacting the hay bale and breaking the bale into clumps or rolling the hay out in layers on the ground over a selected area. In a first preferred embodiment of the invention the roller drum includes a drum spindle extending through the center thereof and journalled for rotation in a frame fixed to a boom that is welded, bolted or otherwise fixed to the front end of a tractor frame, such that the roller drum is suspended above the ground. In a second preferred embodiment of the invention the rotating drum is rotatably attached to a frame that is pivotally connected to an adjustable boom which is pivotally attached to the front of the tractor frame or to the conventional three-point connection on the rear end of the tractor, and may be adjusted either horizontally or vertically by means of a hydraulic cylinder to suspend the rotatable roller drum, typically about six to eight inches above the ground.

In both cases the tractor is maneuvered to contact the hay bale with the roller drum and in the case of a round hay bale, to preferably contact the hay bale when the bale is positioned such that the hay layers are wound or rolled toward the tractor. Operation of the tractor then forces the roller drum against the outer layer of the hay bale and causes the hay bale to unroll or break up on the ground with rotation of the roller drum, to spread the resulting hay in layers or clumps over a selected area.

### BRIEF DESCRIPTION OF THE DRAWINGS

The invention will be better understood by reference to the accompanying drawings wherein:

FIG. 1 is a perspective view of a preferred fixed roller drum embodiment of the hay spreading apparatus of this invention;

FIG. 2 is a side view of the fixed roller drum hay spreading apparatus illustrated in FIG. 1 in functional position, illustrating unwinding or unrolling of the layers of a round hay bale responsive to forward movement of the tractor and free rotation of the roller drum;

FIG. 3 is a side view of the fixed roller drum embodiment of the hay spreading apparatus of this invention illustrated in FIGS. 1 and 2, more particularly illustrating spreading of the hay in the round hay bale; and

FIG. 4 is a perspective view of an adjustable roller drum hay spreading apparatus embodiment of the invention.

### DESCRIPTION OF THE PREFERRED EMBODIMENTS

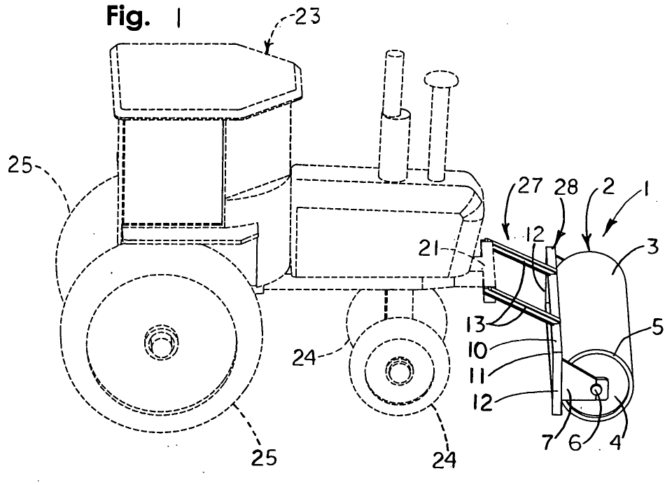

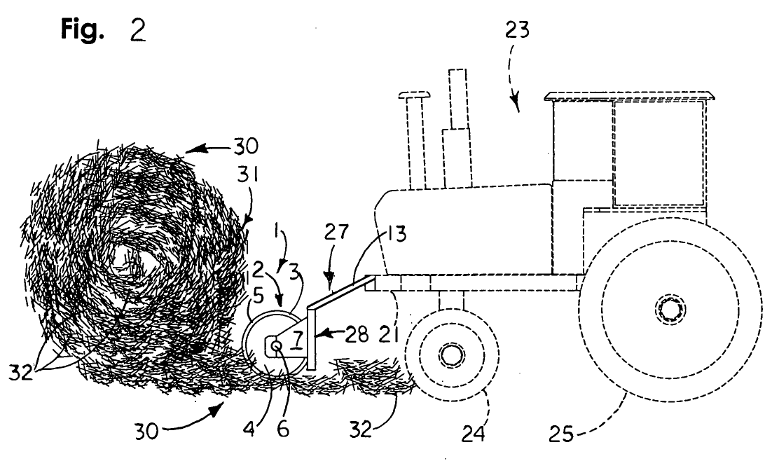

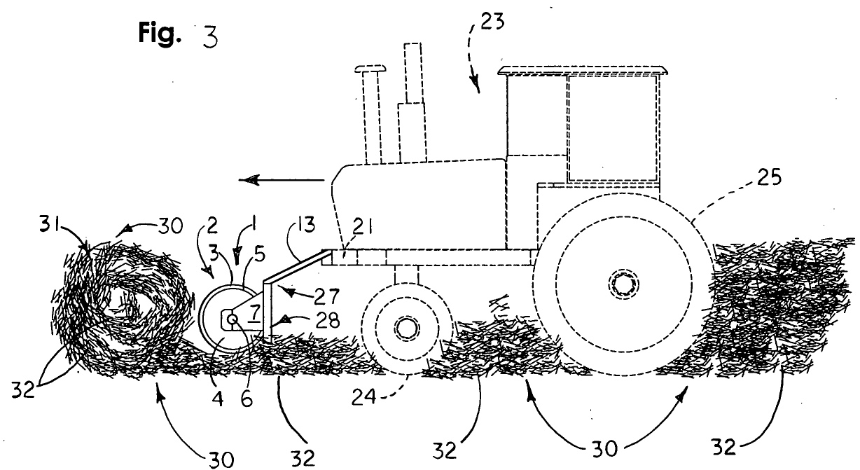

Referring initially to FIGS. 1-3 of the drawings a first preferred embodiment of the hay spreading apparatus of this invention is generally illustrated by reference numeral 1 and includes a roller 2, characterized by a cylindrical roller drum 3, closed by drum ends 4. The roller drum 3 typically has drum rims 5, respectively, on each end and accommodates a drum spindle 6, typically fixedly extending through the centers of the drum ends 4, as illustrated. The drum spindle 6 is rotatably journalled in a pair of spaced-apart spindle mount brackets 7, typically by means of a bushing or bearing (not illustrated), as desired. A fixed boom 27 extends from the tractor frame 21 of a tractor 23, having front wheels 24 and rear wheels 25 (illustrated in phantom). The fixed boom 27 typically includes a pair of parallel boom connectors 13, one end of each of which is fixedly attached by means of welding, bolting or other technique, to the tractor frame 21 and the opposite ends of the parallel boom connectors 13 extending respectively, to fixed attachment by welding, bolting or the like, to the top frame member 10 of a fixed boom frame 28, as further illustrated in FIG. 1 of the drawings. The fixed boom frame 28 is further characterized by a pair of spaced-apart, parallel side frame members 12, extending downwardly from fixed attachment to the top frame member 10 to fixed connection to a bottom frame member 11. Accordingly, in a preferred embodiment of the invention the top frame member 10, bottom frame member 11 and side frame members 12 define a rectangle and the pair of spindle mount brackets 7 that support the drum spindle 6 for rotation, extend from welded, bolted or other connection to the respective side frame members 12 of the fixed boom frame 28, to accommodate and support the roller drum 3 of the roller 2. It will be appreciated from a consideration of FIGS. 1-3 that the roller drum 3 is freely rotatable with the drum spindle 6 (or a pair of drum spindles 6, welded to the drum ends 5) and is typically suspended about six to eight inches above the ground, as illustrated in FIGS. 2 and 3 of the drawings.

Referring again to FIGS. 2 and 3 of the drawings the tractor 23 is operated to position the roller drum 3 of the roller 2 adjacent to the outer one of the hay layers 32 of a wound, round hay bale 31, and distribute the hay 30 in the hay bale 31 over a selected area and provide better access to the hay 30 by cattle. This goal is achieved by operating the tractor 23 forwardly in the direction illustrated by the arrow in FIG. 3 to unroll the respective wound or layered hay layers 32 or break up the hay bale 31 and distribute the hay 30 on the ground, as illustrated. During this procedure the roller drum 3 of the roller 2 typically freely rotates in the clockwise direction due to the force of pushing against the hay bale 31, while the hay bale 31 generally rotates in the opposite or counterclockwise direction, to effectively unroll or break up the respective hay layers 32. Alternatively, it will be appreciated by those skilled in the art that the hay bale 31 may be arranged with the hay layers 32 wound in any direction with respect to the roller drum 3 of the roller 2 of the hay spreading apparatus 1 and contact between the roller 2 and the hay bale 31 will distribute the hay 30 in the hay roll 31 in clumps or layers over the desired area, regardless of the direction of wrap of the hay layers 32 in the hay bale 31.

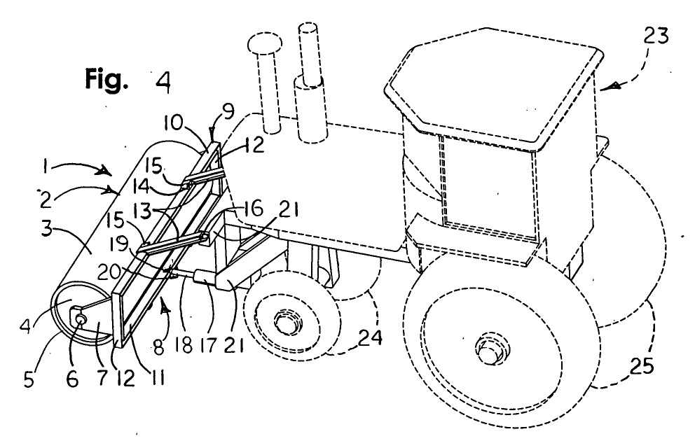

Referring now to FIG. 4 of the drawings in another preferred embodiment of the invention the roller drum 3 of the roller 2 is adjustably mounted with respect to the front end of the tractor frame 21 by means of an adjustable boom 8, which typically includes a pair of spaced-apart boom connectors 13, one end of each of which is pivotally attached to the tractor frame 21, typically by means of respective boom pins 16. The opposite ends of the boom connectors 13 are pivotally attached to the top frame member 10 of an adjustable boom frame 9, typically by a pair of frame connecting pins 14, extending through corresponding frame connecting brackets 15. Furthermore, a hydraulic cylinder 17 has a cylinder end pivotally connected to the tractor frame 21 beneath the boom connectors 13 in any convenient manner, while the cylinder piston 18 of the hydraulic cylinder 17 extends outwardly of the hydraulic cylinder 17 and is pivotally connected to the bottom frame member 11 of the adjustable boom frame 9, typically by means of a piston connecting pin 19, extending through a clevis bracket 20. This pivotal mounting of the hydraulic cylinder 17 to the tractor frame 21 and the cylinder piston 18 to the adjustable boom frame 9 facilitates raising and lowering of the roller 2 with the adjustable boom frame 9, to facilitate positioning the roller drum 3 a desired distance above the ground for breaking up the hay bale 31, as illustrated in FIGS. 2 and 3 of the drawings with respect to the fixed boom embodiment of the hay spreading apparatus 1. Alternatively, the adjustable boom frame 9 can be pivotally connected to the conventional boom connectors and hydraulic cylinder piston of a three-point connection apparatus (not illustrated) provided on the rear end of many tractors. Accordingly, the hay spreading apparatus 1 may be equipped as illustrated in FIG. 4 with the adjustable boom 8, which is operated using the hydraulic cylinder 17 and appropriate hydraulic motors, hoses and controls (not illustrated), according to the knowledge of those skilled in the art, to position the adjustable boom frame 9 and the roller drum 3 of the roller 2 a selected distance above the ground and the roller drum 3 in position in close proximity to the hay bale 31, as illustrated in FIG. 2. The tractor 23 is then operated in the same manner as described above with respect to FIG. 3 to unroll or break up the hay roll 31 and distribute the hay 30, typically in hay layers 32, in a desired distribution along the ground for optimum access by cattle. The orientation of the tractor 23 may be reversed under circumstances where the conventional three-point tractor attachment is used to support the adjustable boom frame 9. Tractors so equipped sometimes use a front-end loader to load, unload and position the hay bales 31.

Referring again to the drawings, it will be appreciated by those skilled in the art that the hay spreading apparatus of this invention, in both the fixed boom and adjustable boom embodiments, is capable of distributing or dispensing the hay 30 by collapsing and breaking up hay bales such as the round hay bale 31 of various size and type, including square hay bales, using the freely-rotating roller 2 mounted on the front or rear of the tractor 23, as described above. For example, under circumstances where a square bale of hay (not illustrated) is to be broken up, the roller 2 can be used to break apart the square bale of hay quickly and easily by contact with the roller drum 3. Furthermore, under circumstances where a hay bale 31 is positioned such that the respective hay layers 32 are wound away from the tractor 23 instead of in the opposite direction, the roller 2 is capable of distributing hay over the desired area of ground by simply contacting the roller drum 3 with the hay roll 31 and pushing the hay roll 31 ahead of the roller 2 to break the hay layers 32 into clumps of various size.

It will be further appreciated by those skilled in the art that the fixed boom 27 and the adjustable boom 8 can be mounted on vehicles other than the tractor 23, including all-terrain vehicles of various size and design and trucks, in non-exclusive particular. Furthermore, one or more boom connectors 13 of the fixed boom 27 can be bolted or otherwise removably mounted to the tractor frame 21 of the tractor 23 or to an alternative vehicle to facilitate removable attachment, as desired. Moreover, the respective boom pins 16 can be removed from the corresponding tractor frame 21 to remove the adjustable boom 8, as desired.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A hay spreading apparatus for mounting on a vehicle and spreading hay, comprising a roller drum journalled for rotation on the vehicle and adapted for contacting and spreading the hay responsive to operation of the vehicle.

2. The hay spreading apparatus of claim 1 comprising a fixed boom carried by the vehicle in fixed relationship and wherein said roller drum is journalled for rotation on said fixed boom.

3. The hay spreading apparatus of claim 2 wherein said fixed boom comprises a pair of fixed boom connectors having one end carried by the vehicle in said fixed relationship and the opposite end of said fixed boom connectors carrying said roller drum for rotation.

4. The hay spreading apparatus of claim 3 comprising a fixed boom frame provided on said opposite end of said fixed boom connectors, a pair of brackets provided on said fixed boom frame and a spindle extending longitudinally through said roller drum, said spindle journalled for rotation in said brackets to facilitate free rotation of said roller drum with said spindle on said brackets.

5. The hay spreading apparatus of claim 1 comprising an adjustable boom carried by the vehicle in adjustable relationship and wherein said roller drum is journalled for rotation on said adjustable boom.

6. The hay spreading apparatus of claim 5 wherein said adjustable boom comprises a pair of adjustable boom connectors having one end pivotally carried by the vehicle in spaced-apart relationship with respect to each other and the opposite end of said adjustable boom connectors pivotally carrying said roller drum for rotation.

7. The hay spreading apparatus of claim 6 comprising an adjustable boom frame provided on said opposite ends of said adjustable boom connectors, a pair of brackets provided on said adjustable boom frame and a spindle extending longitudinally through said roller drum, said spindle journalled for rotation in said brackets to facilitate free rotation of said roller drum with said spindle on said brackets.

8. A hay spreading apparatus for mounting on a tractor and spreading hay from a hay bale, comprising at least one fixed boom connector having one end fixed to the tractor; a fixed boom frame fixed to the opposite end of said fixed boom connector; and a roller drum journalled for rotation on said fixed boom frame for contacting the hay bale and spreading the hay responsive to operation of the tractor.

9. The hay spreading apparatus of claim 8 comprising a pair of brackets provided on said fixed boom frame and a spindle extending longitudinally through said roller drum, said spindle journalled for rotation in said brackets to facilitate free rotation of said roller drum on said brackets.

10. The hay spreading apparatus of claim 8 wherein said at least one fixed boom connector comprises a pair of fixed boom connectors fixed to the tractor and said fixed boom frame in spaced-apart relationship with respect to each other.

11. The hay spreading apparatus of claim 10 comprising a pair of brackets provided on said fixed boom frame and a spindle extending longitudinally through said roller drum, said spindle journalled for rotation in said brackets to facilitate free rotation of said roller drum on said brackets.

12. A hay spreading apparatus for mounting on a tractor and spreading hay from a hay bale, comprising at least one adjustable boom connector having one end pivotally connected to the tractor; an adjustable boom frame pivotally carried by the opposite end of said adjustable boom connector; a fluid-operated cylinder pivotally attached to the tractor and a piston extending from said cylinder, said piston pivotally connected to said adjustable boom frame; and a roller drum journalled for rotation in said adjustable boom frame for contacting the hay bale and spreading the hay responsive to operation of the tractor.

13. The hay spreading apparatus of claim 12 wherein said fluid-operated cylinder comprises a hydraulic cylinder.

14. The hay spreading apparatus of claim 12 comprising a pair of brackets provided on opposite ends of said adjustable boom frame and a spindle extending longitudinally through said roller drum, said spindle journalled for rotation in said brackets to facilitate free rotation of said roller drum on said brackets.

15. The hay spreading apparatus of claim 12 wherein said fluid-operated cylinder comprises a hydraulic cylinder and comprising a pair of brackets provided on opposite ends of said adjustable boom frame and a spindle extending longitudinally through said roller drum, said spindle journalled for rotation in said brackets to facilitate free rotation of said roller on said brackets.

16. The hay spreading apparatus of claim 12 wherein said at least one adjustable boom connector comprises a pair of adjustable boom connectors pivotally attached to the tractor and said adjustable boom frame in spaced-apart relationship with respect to each other.

17. The hay spreading apparatus of claim 16 comprising a pair of brackets provided on opposite ends of said adjustable boom frame and a spindle extending longitudinally through said roller drum, said spindle journalled for rotation in said brackets to facilitate free rotation of said roller drum on said brackets.

18. The hay spreading apparatus of claim 17 wherein said fluid-operating cylinder comprises a hydraulic cylinder.

19. A hay spreading apparatus for mounting on a tractor and spreading hay from a hay bale, comprising a pair of adjustable boom connectors having one end pivotally connected to the tractor; an adjustable boom frame pivotally carried by the opposite end of said adjustable boom connectors, respectively; a pair of brackets provided on opposite ends of said adjustable boom connectors; a fluid-operated cylinder pivotally attached to the tractor beneath said adjustable boom connectors and a piston extending from said cylinder, said piston pivotally connected to said adjustable boom; and a roller drum journalled for rotation in said brackets for contacting the hay bale and spreading the hay responsive to operation of the tractor.

20. The hay spreading apparatus of claim 19 wherein said fluid-operated cylinder comprises a hydraulic cylinder and said adjustable boom connection and said hydraulic cylinder comprise a three-point attachment provided on the tractor.
